(19) United States
(12) Patent Application Publication
(10) Pub. No.: US 2018/0123251 A1
(43) Pub. Date: May 3, 2018

(54) PERIODICALLY RIPPLED ANTENNA

(71) Applicants: THE REGENTS OF THE UNIVERSITY OF CALIFORNIA, Oakland, CA (US); KING ABDULAZIZ CITY FOR SCIENCE AND TECHNOLOGY, Riyadh (SA)

(72) Inventors: Kang L. Wang, Santa Monica, CA (US); Mohsen Yazdani, Los Angeles, CA (US); Aryan Navabi-Shirazi, Los Angeles, CA (US); Pedram Khalili Amiri, Los Angeles, CA (US)

(73) Assignees: THE REGENTS OF THE UNIVERSITY OF CALIFORNIA, Oakland, CA (US); KING ABDULAZIZ CITY FOR SCIENCE AND TECHNOLOGY, Riyadh (SA)

(21) Appl. No.: 15/786,039

(22) Filed: Oct. 17, 2017

Related U.S. Application Data
(63) Continuation of application No. PCT/US2016/028158, filed on Apr. 18, 2016.
(60) Provisional application No. 62/149,583, filed on Apr. 18, 2015.

(51) Int. Cl. H01Q 9/04; H01Q 1/38; H01Q 1/48

(52) U.S. Cl. CPC H01Q 9/0471; H01Q 5/35; H01Q 1/48; H01Q 1/38

(57) ABSTRACT

A periodically-rippled patch antenna structure with metal coated trenches only along one in-plane direction or in two perpendicular in-plane directions on a dielectric substrate and ground plane and methods of fabricating the antenna radiating elements are provided. An optional layer of oxide or nitride can be placed between the substrate and metal layers as an insulation layer. This use of trenches allows for miniaturization of the patch antenna as well as dual-band degeneracy. When a square 1D rippled patch antenna is excited by a microstrip line connected along the ripples, the effective length is longer than with a line orthogonal to the ripples enabling dual mode degeneracy and antennas working at two distinct frequencies of operation.

### CROSS-REFERENCE TO RELATED APPLICATIONS

This application is a 35 U.S.C. § 111(a) continuation of PCT international application number PCT/US2016/028158 filed on Apr. 18, 2016, incorporated herein by reference in its entirety, which claims priority to, and the benefit of, U.S. provisional patent application Ser. No. 62/149,583 filed on Apr. 18, 2015, incorporated herein by reference in its entirety. Priority is claimed to each of the foregoing applications.

The above-referenced PCT international application was published as PCT International Publication No. WO 2016/172056 on Oct. 27, 2016, which publication is incorporated herein by reference in its entirety.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### BACKGROUND

### 1. Technical Field

The present technology pertains generally to electronic device antennas and manufacturing methods, and more particularly to miniaturized microstrip patch antennas and antenna arrays and volume fabrication methods.

### 2. Background Discussion

Microstrip patch antennas are resonant radiating structures consisting generally of a laminate of two parallel conducting layers separated by a single thin dielectric center layer. The upper conducting layer functions as a radiator while the lower conductive layer acts as a ground plane. The radiating patch layer is typically configured with a square, rectangular, circular, or triangular shape but may take any shape. RF power may be fed to patch antennas in different ways such as with a microstrip line, a coaxial probe, aperture coupling and proximity coupling.

However, conventional microstrip antenna designs do have some limitations that may reduce theft practical usefulness, such as restricted operation bandwidth, low gain, and a potential decrease in radiation efficiency due to surface-wave losses. Several approaches have been attempted to increase the bandwidth of patch antennas including: the use of a low dielectric substrate; the use of a reduced ground plane, impedance matching techniques; cutting of a resonant slot in the patch and other antenna geometry configurations as well as multi-resonator stack configurations.

The widespread application of miniaturization techniques, along with multiband operation techniques in the design of RF and microwave planar antennas, has resulted in revolutionary advances and flexibility in communication systems over the past few decades. In particular, multiband operation and size reduction in microstrip patch antenna has received much attention due to their simplicity, conformal nature, low manufacturing cost, and accurate analysis and design using several EM simulators. However, conventional miniaturization techniques with patch antennas have not performed satisfactorily.

For example, it has been observed that the bandwidth of a patch antenna decreases as the thickness of the patch decreases. Another common miniaturization technique in microstrip patch antenna design is the use of dielectric materials with high-permittivity such as high-contrast, low-loss thick ceramic substrates. However, the use of high dielectric constant materials deteriorates the far-field performance of the antenna system due to the existence of surface waves, limiting the applicability of this approach.

The size reduction may also be achieved using artificial magneto-dielectric surfaces and metamaterials. One design method used to produce electrically small rectangular patch antennas involves the use of double positive metamaterial blocks. However, for such rectangular patches, broadside null radiation pattern was obtained in the sub-wavelength regime.

Loading the corners of a patch antenna by shorting-posts and artificial dielectrics has also been attempted as alternatives to high-permittivity materials. However the use of shorting post leads to a much-reduced impedance bandwidth and high cross-polarization in the antenna response.

Therefore, there remains an urgent need to develop more cost-effective approaches for scaling down the minimum feature size and increasing the density of features in microstrip patch antenna arrays. There is also a need for high volume and low cost fabrication methods. The present technology satisfies these needs and is generally an improvement in the art.

### BRIEF SUMMARY

The demand for devices with thin and compact form factors requires small antenna elements. However, it is difficult to accommodate multiple antennas in compact devices because space within these devices is at a premium. The present technology provides reduced size microstrip patch antenna element designs and fabrication methods that allow close packing density of the radiating elements as well as dual mode degeneracy. The microstrip patch antenna elements may be used individually or as components of an array of antenna elements. The microstrip patch antenna elements can also be used in a wide variety of applications ranging from mobile telephones to battlefield surveillance and telemetry systems.

The patch antenna elements have a highly periodic, rippled radiating element of an electrically conductive material disposed upon a thin substrate of a dielectric and a conductive ground plane. In one preferred embodiment, the patch antenna elements utilize a rippled silicon substrate as a template for the deposition of a conductor layer and the patterning of the rippled microstrip patch antenna. For example, highly periodic rippled silicon dioxide substrates in the form of triangular shaped troughs are illustrated. However, the substrates can be patterned with both periodic and/or non-periodic features and troughs with shapes other than triangles can also be used. Substrates with various periodicities as low as 500 nm and as high as 10 μm can also be fabricated.

In one embodiment, the patch is fed by two microstrip matching networks, exciting both TM₁₀ and TM₀₁ modes in the antenna. The square patch structure is designed to be rippled in one direction and flat in the other. This allows for dual mode degeneracy as well as size miniaturization in the patch antenna. Since the patch antenna has two different effective lengths along the two in-plane directions, it has two dominant resonant frequency modes depending on the location of the input excitation port. This allows for miniaturization of the patch antenna as well as dual-band degeneracy. In another embodiment, the structure can also be rippled in both dimensions with different periodicities to achieve two different resonant frequencies.

A fabrication process for the antenna element is also provided. The process includes: forming an oxide layer on a substrate; depositing photoresist over the oxide layer and patterning the photoresist to form a trench pattern of exposed oxide; etching the photoresist and exposed oxide to form a trench pattern of exposed substrate; etching the exposed substrate using the oxide as an etch mask to form V-shaped trenches in the substrate; removing the oxide etch mask to expose the substrate; forming an oxide layer on the exposed substrate as an insulator layer; and depositing a metal layer over the insulator layer; wherein a plurality of metalized parallel trenches is formed; and wherein the trenches are along one in-plane direction or along two perpendicular in-plane directions.

According to one aspect of the technology, a periodically-rippled patch antenna structure is provided with a plurality of metalized periodic parallel trenches positioned along one in-plane direction or along two perpendicular in-plane directions.

Another aspect of the technology is to provide an antenna that has a low profile but is capable of operating on multiple frequency bands, which may be integrated into a wide variety of devices.

A further aspect of the technology is to provide a processing system that uses patterning methods that are easy to implement in high-volume manufacturing facilities for high volume production.

Another aspect of the technology is to provide a rippled patch antenna with features that have tunable dimensions and high antenna performance.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1A is a schematic perspective view of a highly periodic rippled microstrip patch antenna according to one embodiment of the technology.

FIG. 1B is a detailed view of one triangular shaped trough of the patch shown in FIG. 1A.

FIG. 2A is a schematic cross-section showing the formation of an initial oxide layer on a substrate according to one fabrication method.

FIG. 2B is a schematic cross-section showing the patterning of an applied photoresist layer by the application of photolithography.

FIG. 2C is a schematic cross-section showing etching of the oxide layer.

FIG. 2D is a schematic cross-section showing etching of a triangular trough in the substrate.

FIG. 2E is a schematic cross-section showing formation of a second oxide layer.

FIG. 2F is a schematic cross-section showing the deposition of a metal layer on the second oxide layer.

FIG. 3 is a schematic perspective view of flat patch antenna with two excitation ports.

FIG. 4 is a schematic perspective view of a 1D rippled patch antenna with two excitation ports.

FIG. 5 is a graph comparing S-parameter measurements of flat and 1D rippled patch antenna. The solid line, F, is the S-parameter measured for the 4 mm×4 mm flat patch antenna. The dashed curves are the S-parameters for the 1D rippled patch antenna. R₁ is the curve corresponding to the S-parameters measured when the patch antenna is excited along the ripples, while R₂ is the S-parameter measured when the rippled antenna is excited through the port perpendicular to the ripples.

FIG. 6 is a graph comparing the radiation patterns of flat and 1D rippled microstrip patch antennas.

### DETAILED DESCRIPTION

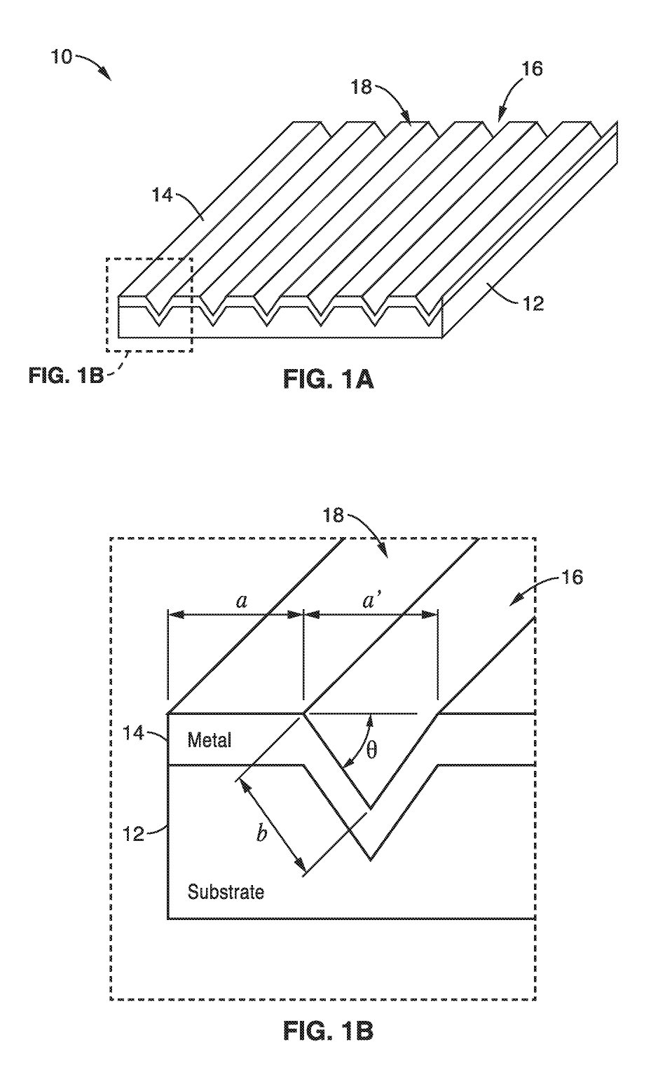

Referring more specifically to the drawings, for illustrative purposes, embodiments of the methods and resulting structures are generally shown. Several embodiments of the technology are described generally in FIG. 1A through FIG. 6 to illustrate the devices and fabrication methods. It will be appreciated that the methods may vary as to the specific steps and sequence and the apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1A through FIG. 1B, one preferred embodiment of a patch antenna radiating structure 10 with a highly periodic triangular shaped rippled substrate according to the technology is shown to illustrate one structure. The periodically-rippled patch antenna structure illustrated in FIG. 1A and FIG. 1B has ripples along only one in-plane direction. However, the antenna structure 10 can also have ripples in two perpendicular in-plane directions as well to enable dual-mode operation, for example. Such antenna structures can reduce the size of antennas available for mobile and wireless devices allowing device sizes to be reduced.

The antenna radiator structure illustrated in FIG. 1A and FIG. 1B has a base substrate 12 that is preferably a dielectric material such as undoped silicon, silicon dioxide or other metal oxides or nitrides. Trenches may be formed in the substrate 12 that are overlaid with a conductor metal layer 14. Each of the periodic ripples in the structure 10 have triangular shaped troughs 16 defining sides and a planar top surface 18.

In the detail shown in FIG. 1B, the period of the pattern is shown as (a+a′). The number and dimensions of the troughs 16 can also be selected to effectively miniaturize the antenna. The magnitude of the miniaturization shown in FIG. 1B can be determined by calculating the actual length of the metal deposited in one period, ∧_{act}, and dividing it by the physical antenna length that it covers, a+a′. In the illustrated rippled antenna, ∧_{act} is equal to a+2b, where b=a/(2 cos θ), assuming a and a′ are equal. Thus, with θ selected to be 54.7 degrees, ∧_{act} is approximately 2.7a. ∧_{act} covers a physical length of 2a on the chip. Therefore, in one period the entire antenna radiating structure can be reduced in length by a factor of 1.36, or by 26% for a given frequency of operation, without compromising the antenna footprint on the board chip.

The illustration shown in FIG. 1A and FIG. 1B show the length of the trench (a′) and the flat region (a) that together produce the period to be the same. Although a 50% trench-50% flat feature is shown, other dimensions for (a) and (a′) can be used. These dimensions can be tuned to obtain a structure where the length covered by the flat region in one period is even smaller than the one presented in the illustration of FIG. 1B. Substrates with various periodicities as low as 500 nm and as high as 10 μm can be fabricated.

The properties of the antenna can also be controlled by tuning the parameters in a rectangular patch antenna design (L, W, h, permittivity). For example, the bandwidth of can be increased by increasing the height (h) or thickness of the substrate. The length (L) of the patch can control the resonant frequency and the width (W) can control the input impedance and radiation patterns. The selection of materials with different permittivities can also influence the impedance, radiation and bandwidth characteristics of the device.

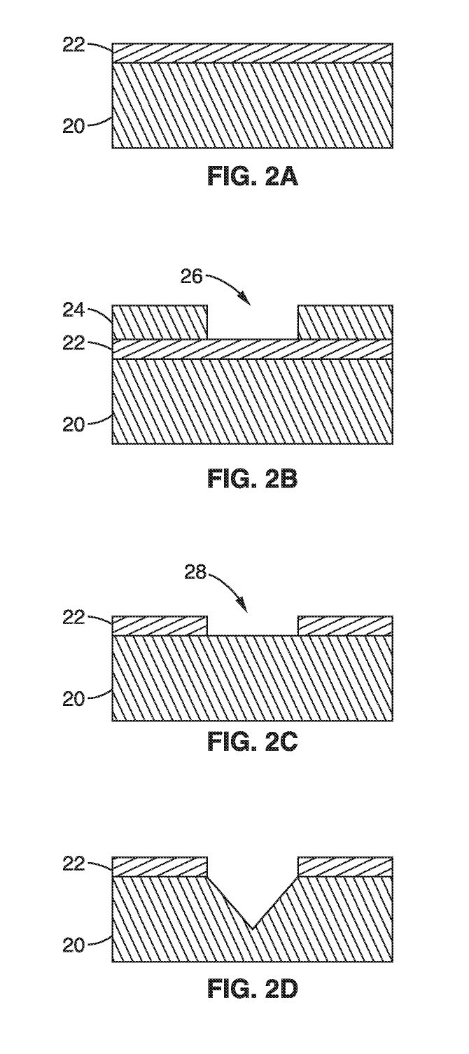

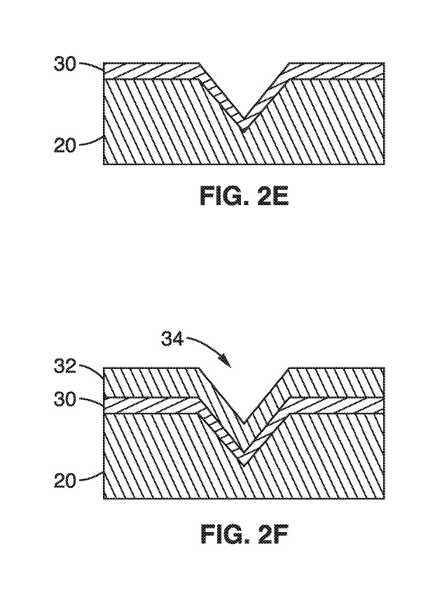

Referring now to FIG. 2A through FIG. 2F, one preferred embodiment of a patterning method to produce a rippled microstrip patch antenna radiating structure using a silicon substrate as a template according to the technology is generally described.

In the embodiment illustrated, a silicon wafer 20 with a (100) crystallographic orientation may be thermally oxidized to grow a layer of oxide 22 to serve as an etch mask, as shown in FIG. 2A. The formed oxide layer 22 can then be patterned with an overlay of photoresist 24. Photolithography can then be used to pattern the photoresist 24 layer with a periodic pattern 26 for the eventual creation of trenches as shown in FIG. 2B.

Dry etching is preferably used to etch the exposed SiO₂ etch mask 22 and create trenches 28 of defined dimensions in the oxide layer 22, spaced at a determined distance apart and exposing the silicon substrate 20 underneath. The photoresist layer 24 can also be removed to reveal the patterned oxide layer as seen in FIG. 2C.

Anisotropic etching of the exposed silicon 28 can then be performed using KOH at 45° C., with the patterned thermal oxide 22 acting as an etch mask, for example. This produces V shape trenches in the silicon of desired dimensions in this illustration as shown in FIG. 2D. The oxide etch mask 22 can then be removed from the silicon substrate 20 using buffered oxide etching (BOE) or some other etching system.

Another thermal oxide layer 30 of a desired thickness can then be grown on the clean and trenched substrate 20 for further substrate insulation as seen in FIG. 2E. Thereafter, a metal layer 32 is disposed over the optional second oxide layer 30 to produce the radiating portion of the antenna structure that has troughs 34 that are metal lined as shown in FIG. 2F. FIG. 2F shows the final cross sectional schematic of the highly periodic radiating portion of the patch antenna.

The invention may be better understood with reference to the accompanying examples, which are intended for purposes of illustration only and should not be construed as in any sense limiting the scope of the present invention as defined in the claims appended hereto.

### EXAMPLE 1

In order to prove the concept of the device and the fabrication methods, a patch antenna device was produced using the methods of the present technology as outlined in FIG. 2A to FIG. 2F and tested. Using the fabrication process outlined, a 4 mm×4 mm 1D rippled patch antenna with 6 μm periodicity was designed and fabricated on a 500 μm undoped silicon substrate. The antenna was then tested in an antenna test chamber. Initially, to produce the antenna, a silicon wafer with a (100) crystallographic orientation was thermally oxidized to grow a 90 nm oxide to serve as an etch mask. Photolithography was used to pattern 3 μm wide trenches in the photoresist. Dry etching was used to etch the exposed SiO₂ etch mask and create 3 μm wide trenches in the oxide, spaced 3 μm apart, thereby exposing the silicon underneath. Anisotropic etching was then performed using KOH at 45° C. with the thermal oxide acting as an etch mask. This produced V shaped trenches in the silicon. The oxide etch mask was then removed using buffered oxide etching (BOE). Another 90 nm thermal oxide was then grown to further insulate the substrate. A metal film was applied to the oxide layer to complete the structure. The periodicity of the patterned chip was 2a and the angle θ was 54.7 degrees.

### EXAMPLE 2

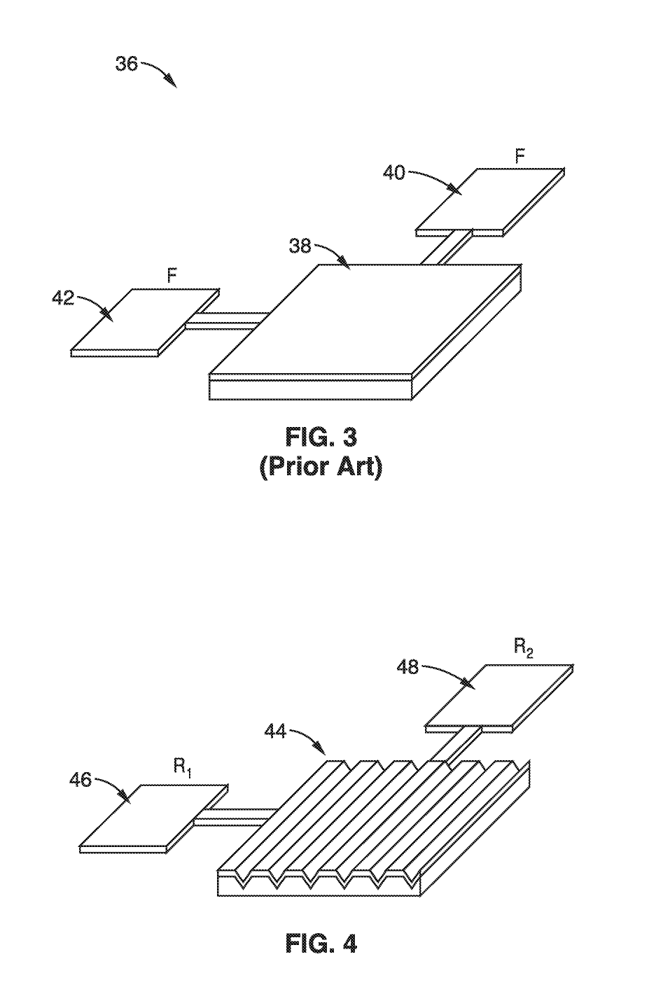

To further demonstrate the technology, a 1D rippled patch antenna was fabricated and compared with a conventional flat patch antenna. FIG. 3 shows a conventional flat patch antenna configuration 36 with a flat patch 38 that is fed by two orthogonal excitation ports 40, 42. Similarly, as shown in FIG. 4, the prototype patch 44 is also fed by two microstrip matching networks 46, 48 exciting both TM₁₀ and TM₀₁ modes in the antenna. The square patch structure 44 was designed to be rippled in one direction and flat in the other. By having two different effective lengths along the two in-plane directions, the structure 44 has two dominant resonant frequency modes depending on the location of the input excitation port. This allows for dual-band degeneracy as well as miniaturization of the patch antenna. In one embodiment, the structure can also be rippled in both dimensions with different periodicities to achieve two different resonant frequencies.

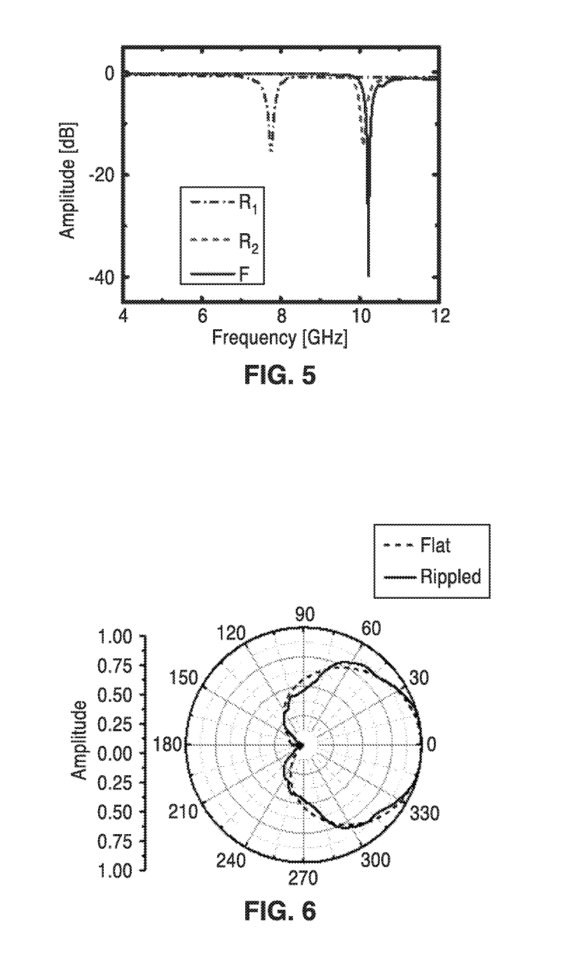

Apart from area reduction, the 1D rippled patch antenna also enables dual mode degeneracy as shown in FIG. 5 and FIG. 6, where S-parameter data of the flat patch antenna shown in FIG. 3 and 1D rippled patch antenna shown in FIG. 4 are compared. FIG. 5 shows a comparison of S-parameter measurements of flat and 1D rippled patch antenna. The solid line, F, is the S-parameter measured for the 4 mm×4 mm flat patch antenna. The dashed curves are the S-parameters for the 1D rippled patch antenna. R₁ is the curve corresponding to the S-parameters measured when the patch antenna is excited along the ripples, while R₂ is the S-parameter measured when the rippled antenna is excited through the port perpendicular to the ripples.

In the graph of FIG. 5, the solid curve shows the measured S-parameter of the flat antenna, showing an insertion loss of 39.7 dB at around 10.2 GHz as expected. When the 1D rippled patch antenna is excited by a microstrip line connected along the ripples, the effective length is longer than 4 mm by a factor of 1.36, i.e., approximately 5.44 mm. The measured S-parameter, from port R₁, shows an insertion loss of 16 dB at 7.7 GHz which is also expected from a flat patch antenna of length 5.44 mm.

The second mode occurs when the 1D rippled patch antenna is excited with a microstrip line that is connected perpendicular to the 1D ripples (from port R₂). The effective length of the antenna along this direction is 4 mm and thus the radiation frequency is near that of the flat 4 mm×4 mm, which is 10.1 GHz displayed as R₂ in FIG. 5.

The radiation pattern of the 1D rippled patch antenna when excited from port R₁ is compared with the flat patch antenna in FIG. 6 showing slight variation in the angles above 45 degrees. The rippled structure can be shaped in to a 1D sinusoidal one to improve performance and increase the magnitude of the insertion loss to match that of a flat antenna.

From the description herein, it will be appreciated that that the present disclosure encompasses multiple embodiments which include, but are not limited to, the following:

1. A microstrip patch antenna apparatus, comprising: (a) a dielectric substrate with a patterned top surface of a plurality of troughs; (b) a ground plane adjacent to the dielectric substrate; (c) a radiating patch of one or more layers of a conductor disposed over the patterned top surface of the substrate; and (d) at least one input excitation port coupled to the conductor.

2. The apparatus of any preceding embodiment, further comprising a layer of a metal oxide between the top surface of the substrate and the conductor layer.

3. The apparatus of any preceding embodiment, wherein the substrate comprises undoped silicon and the oxide layer comprises a silicon dioxide layer.

4. The apparatus of any preceding embodiment, wherein the patterned top surface comprises periodic parallel troughs positioned along one in-plane direction or along two perpendicular in-plane directions.

5. The apparatus of any preceding embodiment, wherein the patterned top surface comprises periodic parallel troughs with a triangular cross-section.

6. The apparatus of any preceding embodiment, wherein the periodic parallel troughs with a triangular cross-section have a trough width and a distance between troughs wherein the distance between troughs and the trough width are equal.

7. The apparatus of any preceding embodiment: wherein the periodic parallel troughs with a triangular cross-section have a trough width and a distance between troughs; and wherein the distance between troughs and the trough width are not equal.

8. The apparatus of any preceding embodiment, wherein the patterned surface comprises a non-periodic surface pattern.

9. The apparatus of any preceding embodiment, further comprising: a second port coupled to the conductor at a position orthogonal to the first port; wherein the structure is a component of a dual mode antenna capable of operating at two distinct frequencies.

10. A microstrip patch antenna apparatus, comprising: (a) a silicon substrate with a patterned top surface of a plurality of troughs; (b) an oxide layer disposed over the patterned top surface of the substrate; (c) at least one radiating patch of one or more layers of a metal conductor disposed over the oxide layer; (d) a first one input excitation port coupled to the conductor; (e) a second port coupled to the conductor at a position orthogonal to the first port; and (f) a ground plane adjacent to the dielectric substrate.

11. The apparatus of any preceding embodiment, wherein the patterned top surface comprises periodic parallel troughs positioned along one in-plane direction or along two perpendicular in-plane directions.

12. The apparatus of any preceding embodiment, wherein the patterned top surface comprises periodic parallel troughs with a triangular cross-section.

13. The apparatus of any preceding embodiment: wherein the periodic parallel troughs with a triangular cross-section have a trough width and a distance between troughs; and wherein the distance between troughs and the trough width are equal.

14. The apparatus of any preceding embodiment: wherein the periodic parallel troughs with a triangular cross-section have a trough width and a distance between troughs; and wherein the distance between troughs and the trough width are not equal.

15. The apparatus of any preceding embodiment, wherein the patterned surface comprises a non-periodic surface pattern.

16. A method for fabricating a periodically-rippled patch antenna structure, the method comprising: forming an oxide layer on a substrate; depositing photoresist over the oxide layer and patterning the photoresist to form a trench pattern of exposed oxide; etching the photoresist and exposed oxide to form a trench pattern of exposed substrate; etching the exposed substrate using the oxide as an etch mask to form trenches in the substrate; removing the oxide etch mask to expose the etched substrate; and depositing a metal layer over the etched substrate; wherein a plurality of metalized parallel trenches is formed; and wherein the trenches are along one in-plane direction or along two perpendicular in-plane directions.

17. The method of any preceding embodiment, further comprising: forming an oxide layer on the etched substrate as an insulator layer; and depositing a metal layer over the insulator layer.

18. The method of any preceding embodiment, wherein the trenches formed in the etched substrate have a triangular shaped cross-section.

19. The method of any preceding embodiment, further comprising: mounting the substrate to a ground plane; and coupling input excitation ports to the metal layer at locations that will produce two dominant resonant frequency modes.

20. The method of any preceding embodiment, further comprising: forming a plurality of patterns of trenches in the substrate; depositing layers of metal on each trench pattern to form an array; and coupling input excitation ports to the metal layer of each trench pattern at locations that will produce two dominant resonant frequency modes for each metal layer of the array.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A microstrip patch antenna apparatus, comprising:
(a) a dielectric substrate with a patterned top surface of a plurality of troughs;
(b) a ground plane adjacent to the dielectric substrate;
(c) a radiating patch of one or more layers of a conductor disposed over the patterned top surface of the substrate; and
(d) an input excitation port coupled to the conductor.

2. The apparatus of claim 1, further comprising a layer of a metal oxide between the top surface of the substrate and the conductor layer.

3. The apparatus of claim 2, wherein said substrate comprises undoped silicon and said oxide layer comprises a silicon dioxide layer.

4. The apparatus of claim 1, wherein said patterned top surface comprises periodic parallel troughs positioned along one in-plane direction or along two perpendicular in-plane directions.

5. The apparatus of claim 1, wherein said patterned top surface comprises periodic parallel troughs with a triangular cross-section.

6. The apparatus of claim 5:
wherein said periodic parallel troughs with a triangular cross-section have a trough width and a distance between troughs; and
wherein the distance between troughs and the trough width are equal.

7. The apparatus of claim 5:
wherein said periodic parallel troughs with a triangular cross-section have a trough width and a distance between troughs; and
wherein the distance between troughs and the trough width are not equal.

8. The apparatus of claim 1, wherein said patterned top surface comprises a non-periodic surface pattern.

9. The apparatus of claim 1, further comprising:
said input excitation port comprising a first input excitation port;
a second input excitation port coupled to the conductor at a position orthogonal to said first input excitation port;
wherein the apparatus is a component of a dual mode antenna capable of operating at two distinct frequencies.

10. A microstrip patch antenna apparatus, comprising:
(a) a silicon substrate with a patterned top surface of a plurality of troughs;
(b) an oxide layer disposed over the patterned top surface of the substrate;
(c) at least one radiating patch of one or more layers of a metal conductor disposed over the oxide layer;
(d) a first input excitation port coupled to the conductor;
(e) a second input excitation port coupled to the conductor at a position orthogonal to the first input excitation port; and
(f) a ground plane adjacent to the substrate.

11. The apparatus of claim 10, wherein said patterned top surface comprises periodic parallel troughs positioned along one in-plane direction or along two perpendicular in-plane directions.

12. The apparatus of claim 10, wherein said patterned top surface comprises periodic parallel troughs with a triangular cross-section.

13. The apparatus of claim 12:
wherein said periodic parallel troughs with a triangular cross-section have a trough width and a distance between troughs; and
wherein the distance between troughs and the trough width are equal.

14. The apparatus of claim 12:
wherein said periodic parallel troughs with a triangular cross-section have a trough width and a distance between troughs; and
wherein the distance between troughs and the trough width are not equal.

15. The apparatus of claim 10, wherein said patterned top surface comprises a non-periodic surface pattern.

16. A method for fabricating a periodically-rippled patch antenna structure, the method comprising:
forming an oxide layer on a substrate;
depositing photoresist over the oxide layer and patterning the photoresist to form a trench pattern of exposed oxide;
etching the photoresist and exposed oxide to form a trench pattern of exposed substrate;
etching the exposed substrate using the oxide as an etch mask to form trenches in the substrate;
removing the oxide etch mask to expose the etched substrate; and
depositing a metal layer over the etched substrate;
wherein a plurality of metalized parallel trenches is formed; and
wherein the trenches are along one in-plane direction or along two perpendicular in-plane directions.

17. The method of claim 16, further comprising:
forming an oxide layer on the etched substrate as an insulator layer; and
depositing a metal layer over the insulator layer.

18. The method of claim 16, wherein said trenches formed in the etched substrate have a triangular shaped cross-section.

19. The method of claim 16, further comprising:
mounting the substrate to a ground plane; and
coupling input excitation ports to the metal layer at locations that will produce two dominant resonant frequency modes.

20. The method of claim 16, further comprising:
forming a plurality of patterns of trenches in the substrate;
depositing layers of metal on each trench pattern to form an array; and
coupling input excitation ports to the metal layer of each trench pattern at locations that will produce two dominant resonant frequency modes for each metal layer of the array.
